(19) United States
(12) Patent Application Publication
(10) Pub. No.: US 2008/0220355 A1
(43) Pub. Date: Sep. 11, 2008

(54) IMAGE CARRIER, LUBRICANT-MOLDED BODY, LUBRICANT APPLICATION DEVICE, IMAGE FORMING APPARATUS AND PROCESS CARTRIDGE

(75) Inventors: Sumio Kamoi, Tokyo (JP); Yuuya Nakatani, Atsugi-shi (JP); Wataru Kikuta, Atsugi-shi (JP); Hiroshi Itoh, Sagamihara-shi (JP)

Correspondence Address: COOPER & DUNHAM, LLP, 1185 AVENUE OF THE AMERICAS, NEW YORK, NY, 10036, US

(73) Assignee: Ricoh Company, Ltd., Tokyo (JP)

(21) Appl. No.: 12/043,767

(22) Filed: Mar. 6, 2008

(30) Foreign Application Priority Data
Mar. 6, 2007 (JP) 2007-055478

(51) Int. Cl. G03C 1/00; G03G 21/00

(52) U.S. Cl. 430/66; 399/350; 399/346

(57) ABSTRACT

An image carrier includes a photosensitive layer which carries a latent image, and a lubricant-coated layer formed on a surface of the photosensitive layer, and the lubricant-coated layer is made of a mixture containing a melaminecyanurate, and a polyimide or a silicone resin.

### PRIORITY CLAIM

The present application is based on and claims priority from Japanese Patent Application No. 2007-055478, filed on Mar. 6, 2007, the disclosures of which is hereby incorporated by reference in its entirety.

### BACKGROUND OF THE INVENTION

1. Field of the Invention

The present invention relates to an image carrier for an electrophotograph on which a lubricant-coated layer is formed on the surface thereof, a lubricant-molded body which is applied on the surface of the image carrier for an electrophotograph, a lubricant application device which applies the lubricant-molded body onto the surface of the image carrier for an electrophotograph, an image forming apparatus having the lubricant application device, and a process cartridge having the lubricant application device.

2. Description of the Related Art

An image carrier generally goes through a repetitive process including a charging step, an exposure step, a developing step, a transferring step, a cleaning step, and a discharging step (or discharging and cleaning). An electrostatic latent image formed by the charging step and the exposure step is visualized by developer containing toners, so as to form a toner image. This toner image is transferred onto a transfer member such as a paper by means of a transferring device. However, the toners are not fully transferred, and some remains on the image carrier. If these residual toners are not eliminated, a high quality unstained image can not be obtained by the repetitive process. For this reason, the cleaning of the residual toners is required. As the cleaning device, a fur brush, a magnetic brush, a blade or the like is typically used. However, the cleaning by means of the blade is mainly adopted in terms of the cleaning accuracy, the device structure or the like.

The cleaning blade for use in cleaning the residual toners includes a supporting body and a plate-like elastic member made of a material such as a polyurethane or the like, which is attached to the supporting member, and is pressed onto the surface of the photosensitive layer so as to have contact therewith. The blade is in a contact state such that contact with the image carrier is in the counter direction relative to the rotation direction of the image carrier, and is a contact state such that contact with the image carrier is in the forward direction relative to the rotation direction of the image carrier. Based on the cleaning accuracy, most of the blades adopt the contact state in the counter direction. The mechanical rubbing of the cleaning blade or the like on the surface of the image carrier causes wear of the surface of the image carrier. If the surface of the photosensitive layer is worn, the photosensitive feature of the image carrier deteriorates. For this reason, an appropriate electrostatic latent image can not be formed. In addition, the increase in the frictional force causes local cracks of the cleaning blade or the fusion of the toners by an increase of the heating value.

The conventional image carrier for forming an image includes a photosensitive layer containing a compound such as zinc oxide (ZnO), cadmium sulfide (CdS), cadmium selenide (CdSe), an amorphous selenium series (a-Se, a-Se—Te, a-As2Se3), or an amorphous silicon series (a-Si: H). Recently, most of the image carriers use a photosensitive layer containing an organic series compound having many advantages such as a simple manufacturing method, a highly sensitive design, low cost and no pollution. For the image carrier containing an organic series compound, a photosensitive layer of a single layer type into which the function of a charge generation material and the function of a charge transport material are incorporated, or a photosensitive layer of a function separation type including a two-layer structure having a charge generation layer and a charge transport layer is mainly used. In the general image carrier containing an organic series compound, which is the function separation type, the charge generation layer is directly disposed on a conductive supporting body, or is disposed thereon via a lower layer (or intermediate layer), and next, a resin layer (charge transport layer) containing a charge transport substance is formed. An inorganic material or an organic material can be used for the charge generation layer. Nowadays, the image carrier containing an organic series compound, which is of the function separation type, is widely used.

In order to deal with recent rapid colorization and high quality images along with the colorization, a polymerized toner having a small diameter, a narrow particle size distribution, and a spheronization is mainly used. A method of manufacturing a toner mainly includes the following grinding method and polymerization method.

(1) Grinding Method

The grinding method is a method of melting and kneading an addition agent such as a coloring agent or a charge control agent in a binder polymer manufactured by the polymerization, coarsely grinding the obtained material, finely grinding the coarsely ground materials, and then classifying the finely ground materials by means of a sieve. The grinding method has the advantage of obtaining a fine-particle toner, but the steps are complex, resulting in an increase in the cost. The toner manufactured by the grinding method has a shape having irregularity (irregular shape). A process for rounding a corner is conducted on such an irregular-shaped toner, so as to use such a toner as a toner for developer. Then, the toners are classified so as to obtain toners each having a particle diameter within a predetermined diameter range. Since the generally used toner has a small degree of circularity (angulated toner), it is difficult for the particle to be uniformly charged. For this reason, there is a problem which causes a transfer error. Moreover, if the toner is held down to the image carrier by the cleaning blade, scratching is easily caused. In addition, even if a sharp image having a high resolution is obtained in the beginning, it is difficult to maintain such an image. If a copy of a copy (second or third copy) is printed, the resolution is extremely deteriorated. For this reason, there is a problem in that such a toner is not so practical. Therefore, a toner in which the sphericity is further increased is developed, but it increases the cost.

(2) Polymerization Method

The polymerization method includes a suspension polymerization method and an emulsion polymerization method. The toner of the suspension polymerization method is manufactured by adding a disperse medium and a dispersing agent into a binder resin monomer into which an addition agent such as a coloring agent or a charge control agent is added, for example, and then copolymerizing this. Since the toner of the polymerization method is of a spherical form in which a particle diameter is made relatively uniform, the polymerization method has an advantage in that a particle having an irregular shape is hardly manufactured. Such a spherical toner in which the particle diameter is made uniform easily uniforms the charging, so the toner most probably adheres onto the latent image. For this reason, the toner of the polymerization method has a transfer efficiency of 99% or more, so a high resolution can be easily obtained. Therefore, the reproducibility of a dotted image is high. Accordingly, recently, the toner of the polymerization method having many advantages is commonly used. However, the degree of circularity of the spherical toner by the polymerization method is 0.98 to 0.998, which is larger than the degree of the circularity of the spherically ground toner of about 0.91 to 0.93, so it has a problem in causing a cleaning error because the toner pushes up the blade, and then passes through the blade in the blade cleaning method.

The reduced diameter and the narrow particle diameter distribution of the toner are advantageous for high resolution development, and also advantageous for the transfer efficiency by the spheronization. Therefore, an image quality such as sharpness of a toner image is remarkably improved. However, if the particle diameter of the toner is reduced, the specific surface area is increased, and the adhesive force of the toner per unit weight to the surface of the image carrier is increased. Therefore, there is a problem in that it becomes difficult to clean the surface of the photosensitive layer. Moreover, if the particle diameter of the toner is reduced, the flowability of the toner is deteriorated, and a large amount of addition agent is required. For this reason, there is a problem in that the wear and cracks of the cleaning blade easily occur, and local scratches are formed on the surface of the image carrier, for example.

If the sphericity of the toner is increased, in the conventionally used counter contact method of the blade, since the toner which passes through the blade is increased, a higher contact pressure more than the contact pressure in the conventional technique is required. However, if the pressure is increased, cracks of the blade by the local shearing force are caused.

In order to solve a defect such as the wear of the cleaning member and the image carrier by reducing the frictional resistance between the image carrier and the cleaning member, a method of applying a lubricant agent onto a surface of a photosensitive layer is used, for example. Conventionally, a fatty acid metallic salt such as a zinc stearate is used. For applying such a lubricant agent onto the surface of the photosensitive layer, a bar-like lubricant molded body is applied onto the surface of the photosensitive layer while grinding the lubricant molded body by means of a brush roller, for example, and then the coated layer of the lubricant agent is formed by sliding a cleaning blade on the surface of the photosensitive layer.

As such a technique, there has been proposed a technique which supplies a fatty acid metallic salt such as zinc stearate onto an image carrier via a charging roller (refer to JP H06-342236A), and a technique which supplies a lubricant agent onto an image carrier via a brush, while controlling the amount of the lubricant agent applied (refer to JP H08-202226A).

However, since the fatty acid metallic salt used in these techniques is decomposed, there is a problem in that the thickness of the lubricant-coated layer is reduced. For this reason, it is necessary to supply a large amount of lubricant agent on the surface of the photosensitive layer. However, if a large amount of the lubricant agent is supplied on the surface of the photosensitive layer, a problem such as toner filming occurs. In addition, since a new lubricant agent is constantly supplied on the surface of the photosensitive layer, it is necessary to increase the size of the bar-like lubricant molded body, resulting in increase in the cost. Moreover, such a lubricant-molded body is manufactured by means of cast molding which fills a die with a molten fatty acid metallic salt. However, since such a lubricant molded body is made of a single component, there is a problem in that the strength in the lubricant-molded body is weak. Therefore, there is a problem in that the lubricant-molded body easily cracks.

### SUMMARY OF THE INVENTION

The present invention has been made in view of the above-described problems.

It is, therefore, a first object of the present invention to provide at low cost an image carrier in which a cleaning performance is improved by the improvement in passing-through a blade, even if a spherical toner is used having a reduced particle diameter which can achieve a high quality image but the cleaning performance is reduced, the wear volume of a cleaning blade is reduced, and the durability is improved by reducing the abraded quantity of a lubricant-coated layer formed on a surface of an image carrier by a charging hazard. A second object of the present invention is to provide a lubricant-molded body having a high strength, which is applied onto the surface of the image carrier, at low cost. A third object of the present invention is to provide a lubricant application device which applies the lubricant-molded body onto the surface of the image carrier, an image forming apparatus having the lubricant application device, and a process cartridge having the lubricant application device at low cost.

In order to solve the above-described problems, for achieving the present invention, the present inventors found that an image carrier can be provided at low cost in which a cleaning performance is improved by the improvement in passing-through a blade, even if a spherical toner having a reduced particle diameter which can achieve a high quality image, but the cleaning performance is reduced is used, the wear volume of the cleaning blade is reduced, and the durability is improved by reducing the abraded quantity of a lubricant coated layer formed on a surface of an image carrier by a charging hazard.

A first aspect of the present invention relates to an image carrier including a photosensitive layer which carries a latent image, and a lubricant-coated layer formed on a surface of the photosensitive layer, the lubricant-coated layer being made of a mixture containing a melaminecyanurate, and a polyimide or a silicone resin.

Preferably, a volume-average particle diameter of the melaminecyanurate and the polyimide or the silicone resin is 1 to 10 μm.

A second aspect of the present invention relates to an image carrier including a photosensitive layer which carries a latent image, and a lubricant-coated layer formed on a surface of the photosensitive layer, the lubricant-coated layer being made of a mixture containing a melaminecyanurate, a polyimide or a silicone resin, and a thermoplastic resin particle.

Preferably, a volume-average particle diameter of the melaminecyanurate, the polyimide or the silicone resin, and the thermoplastic resin particle is 1 to 10 μm.

A third aspect of the present invention relates to a lubricant-molded body including a mixture containing a melaminecyanurate and a polyimide or a silicone resin.

Preferably, a volume-average particle diameter of the melaminecyanurate and the polyimide or the silicone resin is 1 to 10 μm.

A fourth aspect of the present invention relates to a lubricant-molded body including a mixture containing a melaminecyanurate, a polyimide or a silicone resin, and a thermoplastic resin particle.

Preferably, a volume-average particle diameter of the melaminecyanurate, the polyimide or the silicone resin, and the thermoplastic resin particle is 1 to 10 μm.

Preferably, the lubricant-molded body is compressed and molded in a shape of a bar.

Preferably, the lubricant-molded body is compressed and molded in the shape of a bar at a temperature of a melting point or a thermal softening point or more of the thermoplastic resin particle.

A fifth aspect of the present invention relates to a lubricant application device including a lubricant-molded body; and a brush roller which has contact with the lubricant-molded body and an image carrier, supplies a lubricant agent onto a surface of the image carrier while grinding the lubricant molded body, and forms a lubricant application layer, wherein the lubricant-molded body includes the lubricant-molded body according to one embodiment of the present invention.

A sixth aspect of the present invention relates to a process cartridge including an image carrier according to one embodiment of the present invention, a cartridge case which rotatably retains an electrophotograph photoreceptor, and a lubricant application device according to one embodiment of the present invention, which is retained in the cartridge case.

Preferably, the process cartridge further includes a cleaning device, and the lubricant application device is disposed on a more upstream side of the image carrier than the cleaning device.

Preferably, the cleaning device is a cleaning blade.

A seventh aspect of the present invention relates to an image forming apparatus including a process cartridge according to one embodiment of the present invention, a charging device which uniformly charges a surface of an image carrier; an exposure device which exposes onto the surface of the image carrier and forms an electrostatic latent image, a development device which visualizes an image by supplying a toner onto the electrostatic latent image on the surface of the image carrier, a transfer device which transfers a toner image on the surface of the image carrier onto a transfer medium, and a cleaning device which cleans the surface of the image carrier after transfer.

Preferably, the image forming apparatus further includes a lubricant application device according to one embodiment of the present invention, and the lubricant application device is disposed in a position which is on a more downstream side of a moving direction of the image carrier than the transfer device and a more upstream side than the cleaning device.

Preferably, the cleaning device is a cleaning blade.

Preferably, a volume-average particle diameter of a toner for use in the development device is 3 to 8 μm, and a ratio of a volume-average particle diameter (Dv) and a number-average particle diameter (Dn) of the toner for use in the development device is 1.00 to 1.40.

Preferably, an average circularity of a toner for use in the development device is 0.93 to 1.00.

### BRIEF DESCRIPTION OF THE DRAWINGS

These and other features, aspects, and advantages of the present invention will become better understood with regard to the following description, appended claims, and accompanying drawings.

FIG. 1 is a cross-sectional view illustrating an image carrier according to one embodiment of the present invention.

FIG. 2 is a schematic view illustrating an image forming apparatus according to one embodiment of the present invention.

FIG. 3 is a schematic view illustrating a lubricant molded-body according to one embodiment of the present invention.

FIG. 4 is a view illustrating a state in which the lubricant-molded body is molded by a compression molding die according to one embodiment of the present invention.

FIG. 5 is a schematic view illustrating a charging hazard applying device.

FIG. 6 is a schematic view illustrating a test for measuring bending force of a lubricant-molded body.

### DETAILED DESCRIPTION OF THE PREFERRED EMBODIMENTS

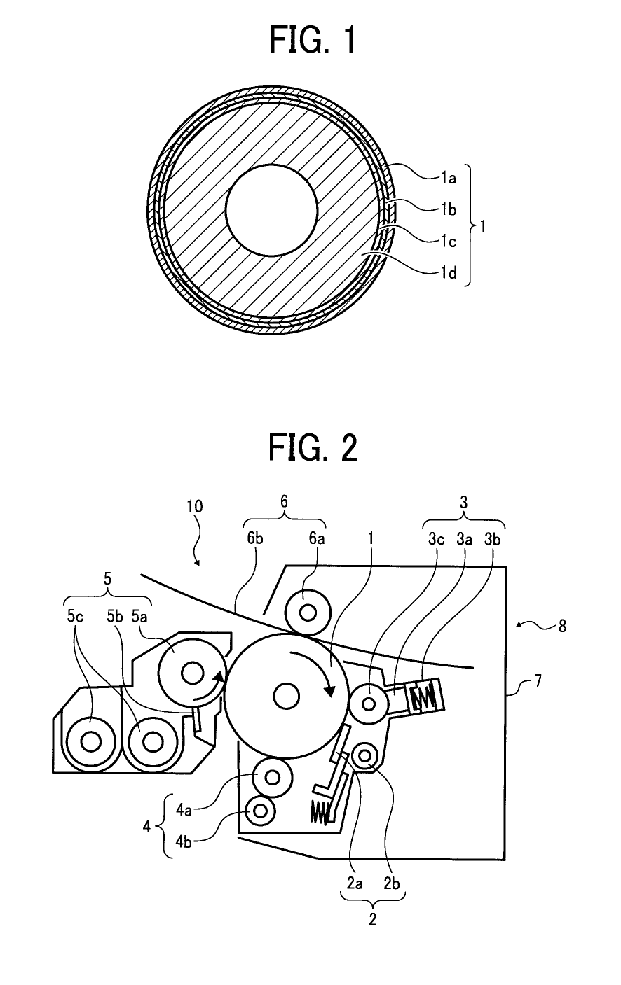

As illustrated in FIG. 1, an image carrier 1 according to the embodiment of the present invention includes a photosensitive layer 1c which carries a latent image, and a lubricant coated layer la formed thereon. The lubricant coated layer la is made of a mixture containing (A) melaminecyanurate and (B) polyimide or silicone resin. As described above, if the lubricant coated layer la is made of the mixture of (A) melaminecyanurate and (B) polyamide or silicone resin, the image carrier can be provided in which the cleaning performance is improved by the improvement in the passing-through the blade even if the spherical toner having a reduced particle diameter, which can achieve a high quality image, but has the reduced cleaning performance, is used, the wear volume of the cleaning blade is reduced, and also the abraded quantity of the lubricant coated layer formed on the surface of the image carrier by the charging hazard is reduced, so as to improve the durability at low cost.

More particularly, according to the embodiment of the present invention, the following advantages can be obtained.

1) Even if the spherical toner which is not well cleaned is used, the passing-through the blade is improved, so the cleaning performance is improved. Therefore, the durability is improved and also a high quality image is obtained. 2) Since the amount of the lubricant agent supplied is decreased by the decreases in the abraded quantity of the layer by the charging hazard, an abnormal image due to the filming of the toner or the lubricant agent onto the surface of the photosensitive layer can be prevented, and also the size of the lubricant-molded body can be reduced, so as to reduce the cost of the lubricant-molded body. 3) With the conventional lubricant agent such as a fatty acid metallic salt (zinc stearate), the surface of the image carrier wears at 10 μm to 20 μm by 60,000 sheets of paper, so the cleaning performance is deteriorated. For this reason, it is necessary to change the cleaning blade or the photoconductive unit ever 60,000 sheets of paper. However, according to the embodiment of the present invention, since the wear volume is decreased to 5 μm to 9 μm, the durability can be improved up to 120,000 sheets of papers. Therefore, the wear volume of the blade can be reduced, and a photoconductive unit having high durability can be provided. 4) With the conventional lubricant agent such as a fatty acid metallic salt (zinc stearate), the lubricant agent adheres onto the charging roller after about 60,000 sheets of paper, and unevenness and stripes are generated on the image. However, according to the embodiment of the present invention, since the charging roller is not contaminated, it is not necessary to change the charging roller. As a result, the photoconductive unit and electrophotograph device each having high durability can be provided.

In the image carrier 1 according to one embodiment of the present invention, it is preferable for the volume-average particle diameter of the melaminecyanurate and the polyimide or the silicone resin to be 1 to 10 μm. As described, if the volume-average particle diameter of the melaminecyanurate and the polyimide or the silicone resin is 1 to 10 μm, the melaminecyanurate and the polyimide or the silicone resin easily form a layer. Therefore, the thickness in the lubricant-coated layer is made uniform.

Moreover, as illustrated in FIG. 1, in the image carrier 1 according to the embodiment of the present invention, the lubricant-coated layer 1a is formed on the surface of the photosensitive layer 1c which carries a latent image. The lubricant-coated layer 1a is made of a mixture containing (A) melaminecyanurate, (B) polyimide or silicone resin, and (C) thermoplastic resin particles. As described, if the lubricant-coated layer 1a is made of the mixture containing (A) melaminecyanurate, (B) polyimide or silicone resin, and (C) thermoplastic resin particles, the image carrier 1 can be provided at low cost in which the cleaning performance is improved by the improvement in the passing-through the blade even if the spherical toner having a reduced particle diameter, which can achieve a high quality image but has a reduced cleaning performance, is used, the wear volume of the cleaning blade is reduced, the durability is improved by reducing the abraded quantity of the lubricant coated layer 1a formed on the surface of the image carrier 1 by the charging hazard, and the generation of the wear stripes by the melaminecyanurate is prevented. In the image carrier 1 according to the embodiment of the present invention, since the charging roller is not contaminated, it is not necessary to change the charging roller. As a result, the photosensitive unit and the electrophotograph device each having high durability can be provided.

In the image carrier 1 according to the embodiment of the present invention, it is preferable for the volume-average particle diameter of the melaminecyanurate, the polyimide or the silicone resin, and the thermoplastic resin particles to be 1 to 10 μm. As described above, if the volume-average particle diameter of the melaminecyanurate and the polyimide or the silicone resin is 1 to 10 μm, the melaminecyanurate and the polyimide or the silicone resin easily form a layer. For this reason, the thickness in the lubricant-coated layer is made uniform.

The melaminecyanurate, the polyimide, and the silicone resin are materials each having low friction coefficients (i). The conventional lubricant agent such as a fatty acid metallic salt (zinc stearate) has μ=0.3 to 0.4. Each of the melaminecyanurate, polyimide, and silicone resin has μ=0.1 to 0.2. The blending quantity of the melaminecyanurate and the polyimide and the blending quantity of the melaminecyanurate and the silicone are appropriately set according to the blend of the thermoplastic resin, the pigment and the shape of the toner material, the thickness and the material of the image carrier protection layer, the structure and the standard of the electrophotograph device, and the molding method of the lubricant agent. When the lubricant-molded body, which forms the lubricant-coated layer, is formed by means of the compression molding, it is preferable for the blending quantity of the polyimide and the silicone resin to be 50 weight % or less because these materials do not have a preferable compressibility.

The melaminecyanurate of the above (A) is in a powdered state, and is a material known as a flame retardant material in a field (refer to JP2001-60414A). This melaminecyanurate is made of a compound in which a melamine and an isocyanuric acid shown in the following general expression are coordinated, and slowly bonded, so the lubricating property develops in the melaminecyanurate powder when the intermolecular structure of such a compound is shifted.

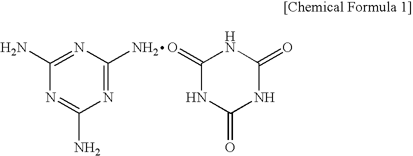

The thermoplastic resin comprising the thermoplastic resin particles of the above (B) is a material such as a polyester series resin, a polyol series resin, a polystyrene series resin, a polyamide series resin, and a polyolefin series resin. The thermal softening point of the material is 50 to 150° C., preferably, 70 to 120° C. If the thermal softening point is too low, the consumption of the lubricant agent (the amount to be ground by a brush) at a high temperature environment (50° C.) is not stabilized. In addition, if the thermal softening point is too high, the adhesion evenness to the image carrier 1 deteriorates. The blending quantity of the thermoplastic resin is appropriately set according to the pigment and the shape of the toner material, the thickness and the material of the image carrier protection layer, the structure and the standard of the electrophotograph device, and the molding method of the lubricant agent. When the mechanical hazard (the number of blades and the blade pressure) is strong, and when the surface protection layer 1b of the image carrier 1 easily deteriorates by the charging hazard, the blending quantity of the thermoplastic resin is increased, so as to blend 30 to 50 weight % of the total.

In the image carrier 1 according to the embodiment of the present invention, the organic semiconductor photosensitive layer 1c, which is a photoconductive material, is provided on a surface of an aluminum cylinder comprising a conductive supporting body 1d of about 30 to 100 mm in diameter. A conductive metal such as an aluminum alloy, nickel, or stainless steel can be used for the conductive supporting body Id, in addition to aluminum. In FIG. 1, the drum-shaped image carrier 1 is used, but a belt-shaped image carrier can be also used. For the image carrier 1, a single layer type in which the functions of a charge generation material and a charge transport material are incorporated into the photosensitive layer 1c, or a function separation type including a two-layer structure having a charge generation layer and a charge transport layer can be adopted. In the general image carrier 1 of the function separation type, the charge generation layer is directly disposed onto the conductive supporting body 1d, or is disposed onto the conductive supporting body 1d via an under layer (intermediate layer), and the resin layer (charge transport layer) containing the charge transport substance is disposed onto the charge generation layer. Especially, if a laminated organic image carrier of the function separation type is used, the freedom of the photosensitive design is increased. For this reason, the laminated organic image carrier having the function separation type is preferable for the image carrier 1.

The charge generation substance of the charge generation layer in the image carrier 1 having the function separation type is not limited to an inorganic material or an organic material. Both of the materials can be used for the charge generation substance. The organic material includes crystal selenium, amorphous selenium, a selenium-tellurium, a selenium-tellurium-halogen, a selenium-arsenic compound, an amorphous silicon or the like. In the amorphous silicon, it is preferable to use a substance in which a dangling-bond is terminated by a hydrogen atom and a halogen atom, or a substance in which a boron atom or a phosphorus atom is doped. On the other hand, as the organic material, a known material can be used. Such a known material includes, for example, a phthalocyanine series pigment such as a metallic phthalocyanine or a metal-free phthalocyanine, an azlenium acid pigment, a squaric acid methane pigment, an azo pigment having a carbazole skeleton, an azo pigment having a triphenylamine skeleton, an azo pigment having a diphenylamine skeleton, an azo pigment having a dibenzothiophene skeleton, an azo pigment having a fluorenone skeleton, an azo pigment having an oxadiazole skeleton, an azo pigment having a bisstilben skeleton, an azo pigment having a distyryloxadiazole skeleton, an azo pigment having a distyrylcarbazole skeleton, a perylene series pigment, an anthraquinone series or a polycyclicquinon series pigment, a quinonimine series pigment, a diphenylmethane or a triphenylmethane series pigment, a benzoquinone or a naphthoquinone series pigment, a cyanine or an azomethane series pigment, an indigoid series pigment, and a bisbenzimidazole series pigment. These charge generation substances are used as a single substance or a mixture containing two kinds or more. It is preferable for the thickness of the charge generation layer to be about 0.01 to 5 μm. It is more preferable for the thickness of the charge generation layer to be about 0.01 to 2 μm. Moreover, it is preferable for the thickness of the charge transport layer to be about 10 to 100 μm. When a resolution is required, the thickness of the charge transport layer is about 10 to 30 μm.

As illustrated in FIG. 1, in the image carrier 1 according to the embodiment of the present invention, it is preferable for a surface protection layer 1b to be disposed between the photoconductive layer 1c and the lubricant coated layer 1a. If the surface protection layer 1b is disposed between the photosensitive layer 1c and the lubricant-coated layer 1a, the surface of the photosensitive layer 1c can be protected.

The surface protection layer 1b has a large number of asperities on the surface thereof. It is preferable for the thickness of the surface protection layer 1b according to the embodiment of the present invention to be 0.1 to 10 μm. If the surface protection layer 1b has a large number of asperities on the surface thereof, the adherence of the lubricant coated layer 1a and the surface protection layer 1b is increased. Therefore, the abraded quantity of the lubricant-coated layer 1a by the cleaning blade can be reduced.

A method of providing asperities on the surface of the surface protection layer 1b is not limited, and a conventionally known method is used, the asperities can be formed on the manufactured surface protection layer 1b of the image carrier 1, or the asperities can be formed in the step of laminating the surface protection layer 1b. Many methods can be applied as the method of providing asperities, for example, a method which directly brings a grinding material into contact with the manufactured surface protection layer 1b of the image carrier 1, so as to scrub the surface of the surface protection layer 1b, a method which indirectly brings grinding particles into contact with the surface protection layer 1b of the image carrier 1 by means of a blast or a grinding device, so as to scrub the surface protection layer 1b, a method which presses a die having an asperity shape onto the surface protection layer 1b of the image carrier 1, so as to transfer the asperity shape onto the surface protection layer 1b, and a method which forms an asperity shape in the step of applying the surface protection layer 1b onto the image carrier 1. A fiber type such as a natural fiber, a chemical fiber, a glass fiber, a felt, or a cloth, a paper type such as a sand paper, or a plastic type such as a film is preferable for the grinding material which has contact with the surface protection layer 1b. However, any type of material can be used for the grinding material as long as the material can form the asperities shape on the surface of the surface protection layer 1b without departing from the object of the present invention. A hard particle such as silica, alumina, diamond, ceric oxide, ceramics, or glass, or a polymer particle such as an urethan, a polyamide, a polyolefin, a polyimide, a polyester, or an acrylic is preferable for the grinding particle. However, any type of material can be used for the grinding material as long as the material can form an asperity shape on the surface of the surface protection layer 1b without departing from the object of the present invention. In addition, as the formed asperity state, it is preferable for the maximum height roughness (Rz) to be 10 nm<5Rz<5000 nm, especially, 100 nm<Rz<1000 nm in the measurement of the freely selected measurement length of 10 μm in terms of the uniformed layer formation of the melaminecyanurate and the adhesiveness of the lubricant coated layer 1a and the surface protection layer 1b.

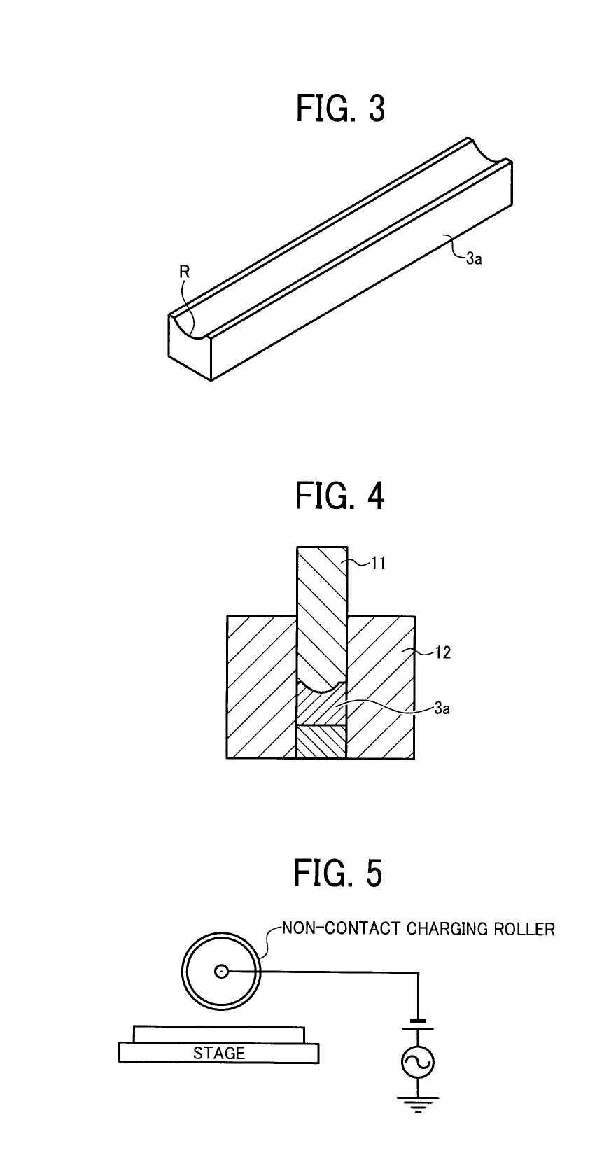

As illustrated in FIG. 3, a lubricant molded body 3a according to the embodiment of the present invention is made of a mixture containing (A) melaminecyanurate and (B) polyimide or silicone resin. It is preferable for the lubricant-molded body 3a to have a groove having a circular arc in cross section. If the lubricant molded body 3a is made of the mixture containing (A) melaminecyanurate and (B) polyimide or silicone resin, the lubricant-molded body is provided at low cost in which the wear volume of the cleaning blade is reduced without deteriorating the cleaning performance even if a reduced diameter spherical toner which can achieve a high quality image is used, and the durability is improved by reducing the abraded quantity of the lubricant coated layer formed on the surface of the image carrier by the charging hazard. In addition, if the lubricant-molded body 3a has the cross-sectional circular arc groove, the molded body can be easily ground by a brush roller.

In the lubricant molded body 3a according to the embodiment of the present invention, the volume-average particle diameter of the melaminecyanurate and the polyimide or silicone resin is 1 to 10 μm. If the volume-average particle diameter of the melaminecyanurate and the polyimide or silicone resin is 1 to 10 μm, the lubricant-coated layer 1a can be formed on the image carrier 1, and also the cleaning performance without having unevenness in the axial direction of the image carrier 1 can be ensured. In addition, such a lubricant-molded body 3a can be compressed and molded by low pressure.

As illustrated in FIG. 3, the lubricant-molded body 3a according to the embodiment of the present invention is made of a mixture containing (A) melaminecyanurate, (B) polyimide or silicone resin, and (C) thermoplastic resin particles. If the lubricant-molded body 3a is made of a mixture containing (A) melaminecyanurate, (B) polyimide or silicone resin, and (C) thermoplastic resin particles, the lubricant-molded body 3a can be provided at low cost in which the wear volume of the cleaning blade is reduced without deteriorating the cleaning performance even if a reduced diameter spherical toner which can achieve a high quality image is used, the durability is improved by reducing the abraded quantity of the lubricant coated layer 1a formed on the surface of the image carrier 1 by the charging hazard, and also the generation of the wear stripes by the melaminecyanurate is prevented. In addition, the strength of the molded body can be increased by the compression molding, so the lubricant molded body in which the generation of the cracks is reduced can be provided.

In the lubricant-molded body 3a according to the embodiment of the present invention, the volume-average particle diameter of the melaminecyanurate, the polyimide or the silicone resin, and the thermoplastic resin particles is 1 to 10 μm. If the volume-average particle diameter of the melaminecyanurate, the polyimide or the silicone resin is 1 to 10 μm, the lubricant-coated layer 1a can be formed on the image carrier 1, and also the cleaning performance without having unevenness in the axial direction of the image carrier 1 can be ensured. In addition, such a lubricant-molded body 3a can be compressed and molded by low pressure.

According to the embodiment of the present invention, it is preferable for the lubricant molded body 3a to be compressed and molded in the shape of a bar. If the lubricant molded body 3a is compressed and molded in the shape of a bar, the strength of the molded body is increased such that it hardly generates cracks. Therefore, the lubricant molded body 3a can be easily applied onto the surface of the image carrier 1. In addition, a thermosetting resin material (silicone or polyimide according to the embodiment of the present invention), which can not be used in a cast molding, an extrusion, and an injection process, can be used, so the choice of material is increased.

According to the embodiment of the present invention, it is preferable for the lubricant-molded body 3a to be compressed and molded in the shape of a bar at a temperature of the melting point of the thermoplastic resin, or a temperature of a thermal softening point or more of the thermoplastic resin. If the lubricant-molded body 3a is compressed and molded in the shape of a bar at the temperature of the melting point of the thermoplastic resin, or the temperature of the thermal softening point or more of the thermoplastic resin, the melted part by the thermoplastic resin and the non-melted part by the melaminecyanurate are mixed in the lubricant-molded body 3a. Therefore, the lubricant-molded body 3a which is tough and can be easily ground can be provided.

As illustrated in FIG. 2, a lubricant application apparatus 3 according to the embodiment of the present invention includes a lubricant-molded body 3a, and a brush roller 3c which forms a lubricant application layer by applying the lubricant agent onto the surface of the image carrier while grinding the lubricant molded body 3a by having contact with both of the lubricant molded body 3a and the image carrier 1. The lubricant molded body 3a is the lubricant-molded body according to the embodiment of the present invention. In FIG. 2, reference number 3b denotes a compressive member which biases the lubricant-molded body 3a onto the brash roller 3c side. The compressive member 3b is a spring such as a compression spring or a plate spring, but it is preferable to use the compression spring. The lubricant-molded body 3a is abraded by the brush roller 3c, and the thickness of the molded body is reduced with time. However, the lubricant-molded body 3a is pressed by the compressive member 3b, so it always has contact with the brush roller 3c. The brush roller 3c applies the lubricant agent to abrade while rotating onto the image carrier 1. If the lubricant-molded body 3a is the lubricant-molded body according to the embodiment of the present invention, the lubricant application device 3, which stably and successively applies the lubricant agent onto the surface of the photosensitive layer 1c for a long period of time, can be provided.

As illustrated in FIG. 2, a process cartridge 8 according to the embodiment of the present invention includes the image carrier 1 according to the embodiment of the present invention, a cartridge case 7 which rotatably retains the image carrier 1, and the lubricant application device 3 according to the embodiment of the present invention which is retained in the cartridge case 7. If the process cartridge 8 includes the image carrier 1 according to the embodiment of the present invention, the cartridge case 7 which rotatably retains the image carrier 1, and the lubricant application device 3 according to the embodiment of the present invention which is retained in the cartridge case 7, the exchanging operation of these parts can become easy. Therefore, the process cartridge 8 in which a time for exchanging parts can be reduced can be provided.

The process cartridge 8 also includes a cleaning device 2 and the lubricant application device 3 disposed in the upstream side of the moving direction of the image carrier 1. If the process cartridge 8 includes the cleaning device 2 and the lubricant application device 3 disposed in the upstream side of the moving direction of the image carrier 1, the lubricant application layer can be formed by applying the lubricant agent onto the surface of the transferred image carrier 1, and also the lubricant-coated layer 1a can be formed by sliding the cleaning device 2 onto the surface of the lubricant agent application layer. Therefore, uniform cleaning performance and uniform charging hazard can be obtained. For this reason, the cleaning performance of the surface of the image carrier 1 can be further maintained for a long period of time, and a higher quality image can be obtained.

The cleaning device 2 includes a cleaning blade 2a. If the cleaning device 2 includes the cleaning blade 2a, the process cartridge 8 capable of supplying a predetermined amount of lubricant agent for a long period of time without adding another scrubbing member can be provided. In FIG. 2, reference number 2b is a toner collection coil.

The cleaning blade 2a is formed by molding an elastic body such as a urethane elastomer, a silicone elastomer, or a fluorine elastomer into a plate shape. The cleaning blade is provided such that the edge is provided to have contact with the surface of the image carrier 1, so as to eliminate the toner and paper powder remaining on the image carrier 1 after the transferring. As the material comprising the cleaning blade 2a, it is especially preferable to use the urethane elastomer in terms of the wear resistance performance and the high mechanical strength. The cleaning blade 2a is attached to a supporting member (not shown) made of a metal, a plastic, ceramics, or the like, so as to be supported, and is disposed at a predetermined angle relative to the image carrier 1. The cleaning blade 2a has contact with the surface of the image carrier 1 at a predetermined contact pressure and impression amount by the pressure with a spring and by fastening to the case of the cleaning device 2.

An image forming apparatus 10 according to the embodiment of the present invention, as illustrated in FIG. 2, includes at least the process cartridge 8 according to the embodiment of the present invention, a charging device 4 which uniformly charges the surface of the image carrier 1, an exposure device (not shown) which forms an electrostatic latent image by exposing onto the surface of the image carrier 1, a development device 5 which visualizes an image by supplying toners to the electrostatic latent image on the surface of the image carrier 1, a transfer device 6 which transfers the toner image on the surface of the image carrier 1 onto a transfer medium (not shown), and the cleaning device 2 which cleans the surface of the image carrier 1 after the transferring.

If the image forming apparatus 10 includes at least the process cartridge 8 according to the embodiment of the present invention, the charging device 4 which uniformly charges the surface of the image carrier 1, the exposure device which forms an electrostatic latent image by exposing onto the surface of the image carrier 1, the development device 5 which visualizes an image by supplying toners to the electrostatic latent image on the surface of the image carrier 1, and the cleaning device 2 which cleans the surface of the image carrier 1 after the transferring, the image forming apparatus in which the abraded quantity of the lubricant-coated layer 1a formed on the surface of the image carrier by the charging hazard can be reduced, and the image carrier 1 having increased duarability, which does not reduce the cleaning performance even if the spherical toner having a reduced particle diameter capable of achieving a high quality image is used, can be obtained so as to obtain a high quality image, can be provided It is preferable for the charging device 4 to have a charging roller 4a and a charging cleaning roller 4b. It is preferable for the development device 5 to have a development sleeve 5a, a screw 5c, and a doctor blade 5b. It is preferable for the transfer device 6 to have a transfer roller 6a and an intermediate transfer belt 6b.

In the image forming apparatus 10 according to the embodiment of the present invention, the lubricant application device 3 according to the embodiment of the present invention is disposed in a position which is on a more downstream side of the moving direction of the image carrier 1 than the transfer device 6 and also on a more upstream side than the cleaning device 2. If the lubricant application device 3 according to the embodiment of the present invention is disposed in the position which is on a more downstream side of the moving direction of the image carrier 1 than the transfer device 6 and also on a more upstream side than the cleaning device 2, the lubricant application layer can be formed by applying the lubricant agent onto the surface of the image carrier 1 after the transferring, and then the lubricant coated layer 1a can be formed by sliding the cleaning device 2 onto the surface of the lubricant application layer. Therefore, uniform cleaning performance and charging hazard can be obtained, and the cleaning performance on the surface of the image carrier 1 can be maintained for a long period of time and also a higher quality image can be obtained.

The cleaning device 2 in the image forming apparatus 10 includes the cleaning blade 2a. If the cleaning device 2 includes the cleaning blade 2a, the image forming apparatus 10, which can easily supply a predetermined amount of lubricant agent for a long period of time without adding another member for scrubbing, can be provided. In FIG. 2, reference number 2b is a toner collection coil.

In the image forming apparatus 10 according to the embodiment of the present invention, it is preferable for the volume-average particle diameter of the toner for use in the development device 5 to be 3 to 8 μm. It is also preferable for the ratio (Dv/Dn) of the volume-average particle diameter (Dv) and the number-average particle diameter (Dn) of the toner for use in the development device 5 to be 1.00 to 1.40.

In general, if a toner having a reduced particle diameter is used in the development device 5, the toner can be precisely adhered onto the latent image. However, if the volume-average particle diameter is less than 3 μm, and the toner is used as the two-component developer, the fusion of the toner occurs onto the surface of the magnetic carrier in the long-term agitation in the development device 5, so the charging ability of the magnetic carrier is decreased. In addition, if the toner is used as a single-component developer, the filming of the toner to the development roller and the fusion of the toner to the member such as the blade for reducing the thickness of the toner are easily caused. On the other hand, if the volume-average particle diameter of the toner exceeds 8 μm, it becomes difficult to obtain a high quality image at a high resolution, and the fluctuation of the particle diameter of the toner is increased when balancing the toner in the developer. In addition, by narrowing the particle diameter distribution, the charging amount distribution of the toner is equalized, and a high quality image can be obtained, so the transfer rate can be improved. However, if Dv/Dn exceeds 1.40, it is not preferable because the charging amount distribution is increased and the resolution is decreased.

Therefore, if the volume-average particle diameter of the toner for use in the development device 5 is 3 to 5 μm and the ratio (Dv/Dn) of the volume-average particle diameter (Dv) and the number-average particle diameter (Dn) of the toner for use in the development device 5 is 1.00 to 1.40, the toner can be precisely adhered onto the latent image, and also the charging amount distribution of the toner is made uniform, so the transfer rate is increased. For this reason, the image forming apparatus 10 capable of obtaining an image having a higher quality can be provided.

In the image forming apparatus 10 according to the embodiment of the present invention, it is preferable for the average circularity of the toner for use in the development device 5 to be 0.93 to 1.00. If the average circularity of the toner for use in the development device 5 is 0.93 to 1.00, the minute filling can be achieved. For this reason, the image forming apparatus 10 capable of obtaining an image having a higher quality can be provided.

### EXAMPLE 1

Melaminecyanurate 80 pts.wt. having a 5.7 μm volume-average particle diameter and polyimide 20 pts.wt. having a 7.2 μm volume-average particle diameter are powder-blended, so as to obtain a powder blend. The powder blending is filled in the compression molding die having an upper die 11 and a lower die 12 illustrated in FIG. 4, and compressed and molded at the pressure of 550 kg/cm². Then, a bar member of 6.0 mm width, 6.5 mm height, and 31.2 cm length is formed. A heat treatment is conducted on the bar member at the temperature of 150° C. for 20 minutes, and a bar-shaped lubricant-molded member in a bar shape is obtained.

### EXAMPLE 2

Melaminecyanurate 90 pts.wt.having a 5.7 μm volume-average particle diameter and silicone particles 10 pts.wt. having a 6.0 μm volume-average particle diameter are powder-blended, so as to obtain a powder blend. The power blend is filled in the compression molding die having the upper die 11 and the lower die 12 illustrated in FIG. 4, and is compressed and molded at the pressure of 550 kg/cm². Then, a bar member of 6.0 mm width, 6.5 mm height, and 31.2 cm length having an R-shaped top part illustrated in FIG. 3 is obtained. A heat treatment is conducted on the bar member at the temperature of 150° C. for 20 minutes, and a bar-shaped lubricant-molded body is obtained.

### EXAMPLE 3

Melaminecyanurate 40 pts.wt. having a 5.7 μm volume-average particle diameter, coarse zinc stearate 55 pts.wt. containing particles of 1 to 3 mm in the maximum diameter, and silicone particles 5 pts.wt. are powder-blended, so as to obtain a powder blend. The power blend is filled in the compression molding die having the upper die 11 and the lower die 12 illustrated in FIG. 4, and is compressed and molded at the pressure of 550 kg/cm². Then, a bar member of 6.0 mm width, 6.5 mm height, and 31.2 cm length having an R-shaped top part illustrated in FIG. 3 is obtained. A heat treatment is conducted on the bar member at the temperature of 120° C. for 20 minutes, and a bar-shaped lubricant-molded body is obtained.

### COMPARATIVE EXAMPLE 1

After injection-molding zinc stearate at the injection temperature of 130° C., the injection pressure of 80 kg/cm², and the injection speed of 10%, a die is opened, and a bar-shaped lubricant molded body is obtained.

As to the lubricant-molded body obtained in each of the Examples 1 to 3 and the Comparative Example 1, (1) cleaning performance, (2) layer abraded quantity by charging hazard, (3) cleaning blade wear volume, and (4) charging roller stain are measured by means of the following evaluation methods.

### (1) Cleaning Performance

The lubricant-molded body obtained in each of the Example 1 to 3, and the Comparative Example 1 is attached to the cleaning device in a digital copier (imagio Neo C335 manufactured by RICOH CO., Ltd.) (refer to FIG. 2). After the lubricant application layer is formed by applying the lubricant-molded body onto the surface of the image carrier by means of the brush roller, the lubricant-coated layer is formed by sliding the cleaning device onto the lubricant application layer, and the cleaning performance of the lubricant-coated layer is evaluated. In this case, the toner having a 6 μm volume-average particle diameter, and 1.2 of the ratio (Dv/Dn) of the volume-average particle diameter (Dv) and the number-average particle diameter (Dn) is used. The evaluation standards by visual evaluations are the following 5 ranks.
Rank 5: passing-through of toner is not recognized.
Rank 4: passing-through of toner is 1.
Rank 3: passing-through of toner is 2 to 10.
Rank 2: passing-through of toner is 11 to 50.
Rank 1: passing-through of toner is recognized in the entire area.

### (2) Abraded Amount by Charging Hazard

As illustrated in FIG. 5, after forming the lubricant-coated layer onto a stage by using the lubricant-molded body obtained in each of the examples 1 to 3 and the Comparative Example 1, a voltage is applied to the lubricant-coated layer by means of a non-contact charging roller under the charging conditions of Vpp: 3.0 kV, Vdc: −600V, F: 1.35 kHz, and charging accumulated time: 18 seconds. Then, the abraded quantity of the lubricant-coated layer, i.e., a ratio (%) of the lubricant-coated layer after the charging voltage is applied for 18 seconds to the layer thickness of the lubricant-coated layer before the test is measured.

### (3) Bending Strength

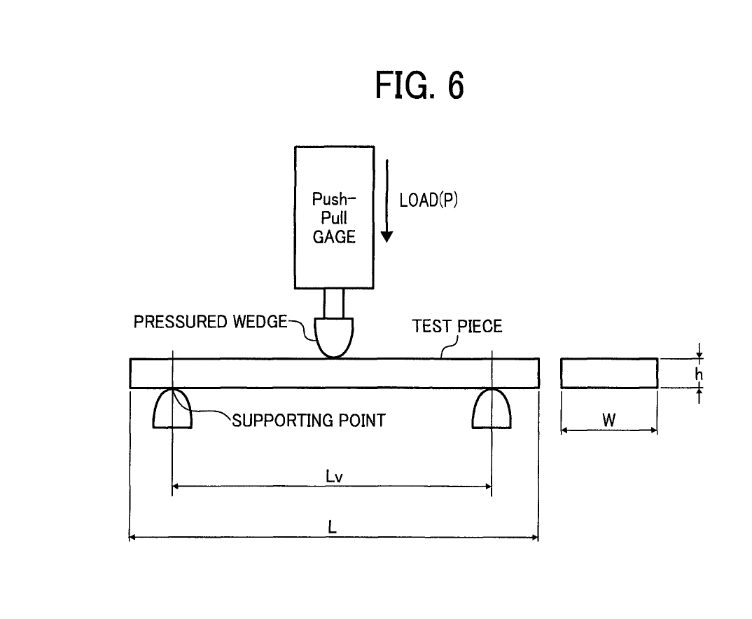

As illustrated in FIG. 6, the lubricant-molded body obtained in each of the Examples 1 to 3 and the Comparative Example 1 is horizontally supported by two supporting points, and a load (P) is applied by means of a pressure wedge to the central portion of the molded body from the upper part. Then, the maximum load till the lubricant-molded body is fractured is read, and the bending strength (σfb) is measured by the following formula σfb=3 PLv/2 Wh², where σfb is a bending strength (kgf/mm²), P is the maximum load (kgf), Lv is a distance (mm) between the supporting points, W (mm) is a width of a test piece, and h is a thickness (mm) in the test piece.

The measurement results are as illustrated in the following Table 1.

TABLE 1

| | SPHERICAL TONER CLEANING | | | | ABRADED | CLEANING | |
|---|---|---|---|---|---|---|---|
| | PERFORMANCE EVALUATION RANK | | | | QUANTITY | BLADE | |
| | | 20K | 60K | 120K | BY CHARGING | WEAR | CHARGING |
| | BEGINNING | PAPER | PAPER | PAPER | HAZARD (μm) *1 | VOLUME (μm) *2 | ROLLER STAIN |
| Embodiment 1 | 5 | 5 | 5 | 4 | 1.5 | 2.2 | NO |
| Embodiment 2 | 5 | 5 | 5 | 4 | 0.5 | 3.5 | NO |
| Embodiment 3 | 5 | 5 | 5 | 4 | 0.3 | 4 | NO |
| Comparative example 1 | 5 | 4 | 4 | 3 | 0 | 15 | YES (IMAGE |
| | | | | | | | STRIPE) |

*1: measurement after 60,000 sheets of paper, target value 2.5 μm or below.
*2: measurement after 60,000 sheets of paper, target value 10 μm or below.

According to Table 1, in the example 1 to 3, the following 1 to 4 are known. 1) The cleaning performance is favorable even if a spherical toner having a reduced diameter is used which can achieve a high quality image. 2) The abraded quantity of the lubricant-coated layer on the image carrier when charging is reduced, which is within a target value. 3) The wear volume of the cleaning blade is reduced, which is within a target value. 4) The stain of the charging roller is not generated. On the other hand, in the Comparative Example 1, the following 1 and 2 are known. 1) The cleaning rank is decreased if 20,000 sheets of paper are passed. 2) The wear volume of the cleaning blade is large.

According to the embodiment of the present invention, the image carrier includes the photosensitive layer which carries a latent image and the lubricant-coated layer formed on the surface of the photosensitive layer. The lubricant coated layer 1 is made of a mixture containing a melaminecyanurate, and a polyimide or a silicone resin. Therefore, the image carrier can be provided at low cost in which the cleaning performance is improved by the improvement in the passing-through the blade even if the spherical toner having a reduced particle diameter which can achieve a high quality image, but has a reduced cleaning performance is used, and the wear volume of the cleaning blade is reduced, and the durability is improved by reducing the abraded quantity of the lubricant-coated layer formed on the surface of the image carrier by the charging hazard.

According to the embodiment of the present invention, the volume-average particle diameter of the melaminecyanurate and the polyimide or the silicone resin is 1 to 10 μm. Therefore, the melaminecyanurate and the polyimide or the silicone resin easily form a layer, so the image carrier in which the thickness of the lubricant-coated layer is made uniform can be provided.

According to the embodiment of the present invention, the image carrier includes the photosensitive layer which carries a latent image, and the lubricant-coated layer formed on the surface of the photosensitive layer, and the lubricant-coated layer is made of a mixture containing a melaminecyanurate, a polyimide or a silicone resin, and a thermoplastic resin particles. Therefore, the image carrier can be provided at low cost in which the cleaning performance is improved by the improvement in the passing-through the blade even if the spherical toner having a reduced particle diameter which can achieve a high quality image, but has a reduced cleaning performance is used, and the wear volume of the cleaning blade is reduced, the durability is improved by reducing the abraded quantity of the lubricant-coated layer formed on the surface of the image carrier by the charging hazard, and also the generation of the wear stripes by the melaminecyanurate is prevented.

According to the embodiment of the present invention, the volume-average particle diameter of the melaminecyanurate, the polyimide or the silicone resin, and the thermoplastic resin particles is 1 to 10 μm. Therefore, the melaminecyanurate, the polyimide or the silicone resin, and the thermoplastic resin particles easily form a layer, so the image carrier in which the thickness of the lubricant-coated layer is made uniform can be provided.

According to the embodiment of the present invention, the lubricant-molded body includes a mixture containing a melaminecyanurate and a polyimide or a silicone resin. Therefore, the lubricant-molded body can be provided at low cost in which the cleaning performance is improved by the improvement in the passing-through the blade even if the spherical toner having a reduced particle diameter which can achieve a high quality image, but has a reduced cleaning performance is used, and the wear volume of the cleaning blade is reduced, and the durability is improved by reducing the abraded quantity of the lubricant-coated layer formed on the surface of the image carrier by the charging hazard.

According to the embodiment of the present invention, the volume-average particle diameter of the melaminecyanurate and the polyimide or the silicone resin is 1 to 10 μm. Therefore, the lubricant-coated layer can be formed on the image carrier, and the lubricant-molded body capable of ensuring the cleaning performance without having unevenness in the axial direction of the image carrier can be provided. In addition, the lubricant-molded body can be compressed and molded at low pressure.

According to the embodiment of the present invention, the lubricant-molded body includes a mixture containing a melaminecyanurate, a polyimide or a silicone resin, and thermoplastic resin particles. Therefore, the lubricant-molded body can be provided at low cost in which the cleaning performance is improved by the improvement in the passing-through the blade even if the spherical toner having a reduced particle diameter which can achieve a high quality image, but has a reduced cleaning performance is used, and the wear volume of the cleaning blade is reduced, the durability is improved by reducing the abraded quantity of the lubricant-coated layer formed on the surface of the image carrier by the charging hazard, and also the generation of the wear stripes by the melaminecyanurate is prevented. In addition, by the compression and molding, the strength can be increased, so the lubricant-molded body which hardly generates cracks can be provided.

According to the embodiment of the present invention, the volume-average particle diameter of the melaminecyanurate, the polyimide or the silicone resin, and the thermoplastic resin particles is 1 to 10 μm. Therefore, the lubricant coated layer containing the uniformed melaminecyanurate, polyimide or silicone resin, and thermoplastic resin particles can be formed on the image carrier, and also the lubricant-molded body capable of ensuring the cleaning performance without having unevenness in the axial direction of the image carrier can be provided. Moreover, the lubricant-molded body can be compressed and molded at low pressure.

According to the embodiment of the present invention, the lubricant-molded body is compressed and molded in the shape of a bar. Therefore, the strength is increased so that the cracks are hardly generated. For this reason, the lubricant-molded body can be easily applied on the surface of the image carrier. In addition, the thermosetting resin material (silicone or polyimide according to the embodiment of the present invention), which can not be used in the cast molding, the extrusion, and the injection method, can be used. Accordingly, the choice of material is increased.

According to the embodiment of the present invention, the lubricant-molded body is compressed and molded in the shape of bar at a temperature of a melting point or a thermal softening point or more of the thermoplastic resin particle. Therefore, the lubricant-molded body can be easily ground, and also is hardly bent.

According to the embodiment of the present invention, the lubricant application device includes the lubricant-molded body and the brush roller which has contact with the lubricant-molded body and the image carrier, supplies the lubricant agent onto the surface of the image carrier while grinding the lubricant-molded body, and forms the lubricant application layer, and the lubricant-molded body includes the lubricant-molded body according to the embodiment of the present invention. Therefore, the lubricant agent can be stably and continuously applied on the surface of the photosensitive layer for a long period of time.

According to the embodiment of the present invention, the process cartridge includes the image carrier according to the embodiment of the present invention, the cartridge case which rotatably retains the electrophotograph photoreceptor, and the lubricant application device according to one embodiment of the present invention, which is retained in the cartridge case. Therefore, the exchanging operations for these parts can be easily conducted, so the time for exchanging a part can be reduced.

According to the embodiment of the present invention, the process cartridge further includes a cleaning device, and the lubricant application device is disposed on the more upstream side of the image carrier than the cleaning device. Therefore, the lubricant application layer can be formed by applying the lubricant agent onto the surface of the image carrier after the transfer, and then the lubricant-coated layer can be formed by sliding the cleaning blade on the surface of the lubricant application layer. For this reason, the uniform cleaning performance and the charging hazard can be obtained, so the cleaning performance on the surface of the image carrier can be maintained for a long period of time, and a further high quality image can be obtained.

According to the embodiment of the present invention, the cleaning device is the cleaning blade. Accordingly, the process cartridge, which can easily supply a predetermined amount of lubricant agent for a long period of time without adding another member for scrubbing, can be provided.

According to the embodiment of the present invention, the image forming apparatus includes the process cartridge according the embodiment of the present invention, the charging device which uniformly charges the surface of the image carrier, the exposure device which exposes onto the surface of the image carrier and forms the electrostatic latent image, the development device which visualizes an image by supplying a toner onto the electrostatic latent image on the surface of the image carrier, the transfer device which transfers the toner image on the surface of the image carrier onto the transfer medium, and the cleaning device which cleans the surface of the image carrier after transfer. Accordingly, the image carrier can be provided in whihc the abraded quantity of the lubricant coated layer formed on the surface of the image carrier by the charging hazard can be reduced, and also the durability is increased, which can not reduce the cleaning performance even if the spherical toner having a reduced particle diameter which can achieve a high quality image is used. For this reason, a high quality image can be obtained.

According to the embodiment of the present invention, the lubricant application device is disposed in a position which is on a more downstream side of a moving direction of the image carrier than the transfer device and a more upstream side than the cleaning device. Therefore, the lubricant application layer can be formed by applying the lubricant agent onto the surface of the image carrier after the transfer, and then the lubricant-coated layer can be formed by sliding the cleaning blade on the surface of the lubricant application layer. For this reason, the uniform cleaning performance and the charging hazard can be obtained, so the cleaning performance on the surface of the image carrier can be maintained for a long period of time, and a further high quality image can be obtained.

According to the embodiment of the present invention, the cleaning device is a cleaning blade. Accordingly, the image forming apparatus, which can easily supply a predetermined amount of lubricant agent for a long period of time without adding another member for scrubbing, can be provided.

According to the embodiment of the present invention, the volume-average particle diameter of a toner for use in the development device is 3 to 8 μm, and the ratio of the volume-average particle diameter (Dv) and the number-average particle diameter (Dn) of the toner for use in the development device is 1.00 to 1.40. Accordingly, the toner can be precisely adhered onto the latent image, and also the charging amount distribution of the toner is made uniform, and the transfer rate is increased. Therefore, a further high quality image can be obtained.

According to the embodiment of the present invention, the average circularity of a toner for use in the development device is 0.93 to 1.00. Therefore, the precise filling can be conducted, so the image forming apparatus capable obtaining a higher quality image can be provided.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. An image carrier, comprising:
a photosensitive layer which carries a latent image; and
a lubricant-coated layer formed on a surface of the photosensitive layer,
the lubricant-coated layer being made of a mixture containing a melaminecyanurate, and a polyimide or a silicone resin.

2. An image carrier according to claim 1, wherein a volume-average particle diameter of the melaminecyanurate and the polyimide or the silicone resin is 1 to 10 μm.

3. An image carrier according to claim 1, wherein the lubricant-coated layer is made of a mixture containing the melaminecyanurate, the polyimide or the silicone resin, and thermoplastic resin particles.

4. An image carrier according to claim 3, wherein a volume-average particle diameter of the melaminecyanurate, the polyimide or the silicone resin, and the thermoplastic resin particles is 1 to 10 μm.

5. A lubricant-molded body, comprising a mixture containing a melaminecyanurate and a polyimide or a silicone resin.

6. A lubricant-molded body according to claim 5, wherein a volume-average particle diameter of the melaminecyanurate and the polyimide or the silicone resin is 1 to 10 μm.

7. A lubricant-molded body, comprising a mixture containing a melaminecyanurate, a polyimide or a silicone resin, and thermoplastic resin particles.

8. A lubricant-molded body according to claim 7, wherein a volume-average particle diameter of the melaminecyanurate, the polyimide or the silicone resin, and the thermoplastic resin particles is 1 to 10 μm.

9. A lubricant-molded body according to claim 5, wherein the lubricant-molded body is compressed and molded in a shape of a bar.

10. A lubricant-molded body according to claim 9, wherein, the lubricant-molded body is compressed and molded in the shape of a bar at a temperature of a melting point or a thermal softening point or more of the thermoplastic resin particles.

11. A lubricant application device, comprising:
a lubricant-molded body; and
a brush roller which has contact with the lubricant-molded body and an image carrier, supplies a lubricant agent onto a surface of the image carrier while grinding the lubricant-molded body, and forms a lubricant application layer, wherein
the lubricant molded body includes the lubricant-molded body according to claim 5.

12. A process cartridge, comprising:
an image carrier according to claim 1,
a cartridge case which rotatably retains an electrophotograph photoreceptor; and
a lubricant application device according to claim 11, which is retained in the cartridge case.

13. A process cartridge according to claim 12 further comprising a cleaning device, wherein the lubricant application device is disposed on a more upstream side of the image carrier than the cleaning device.

14. A process cartridge according to claim 13, wherein the cleaning device is a cleaning blade.

15. An image forming apparatus, comprising:
a process cartridge according to claim 12,
a charging device which uniformly charges a surface of an image carrier;
an exposure device which exposes onto the surface of the image carrier and forms an electrostatic latent image;
a development device which visualizes an image by supplying a toner onto the electrostatic latent image on the surface of the image carrier;
a transfer device which transfers a toner image on the surface of the image carrier onto a transfer medium; and
a cleaning device which cleans the surface of the image carrier after transfer.

16. An image forming apparatus according to claim 15, further comprising a lubricant application device according to claim 11, wherein the lubricant application device is disposed in a position which is a more downstream side of a moving direction of the image carrier than the transfer device and a more upstream side than the cleaning device.

17. An image forming apparatus according to claim 15, wherein the cleaning device is a cleaning blade.

18. An image forming apparatus according to claim 15, wherein a volume-average particle diameter of a toner for use in the development device is 3 to 8 μm, and a ratio of a volume-average particle diameter (Dv) and a number-average particle diameter (Dn) of the toner for use in the development device is 1.00 to 1.40.

19. An image forming apparatus according to claim 15, wherein an average circularity of a toner for use in the development device is 0.93 to 1.00.
